(19) United States
(12) Patent Application Publication
(10) Pub. No.: US 2009/0249178 A1
(43) Pub. Date: Oct. 1, 2009

(54) Document linking

(76) Inventors: Timothy J. Ambrosino, Virginia Beach, VA (US); Jonathan B. Edwards, Virginia Beach, VA (US); Kevin Michael Curry, Virginia Beach, VA (US); Ted E. Ingalsbe, Virginia Beach, VA (US)

Correspondence Address: PROSKAUER ROSE LLP, ONE INTERNATIONAL PLACE, BOSTON, MA, 02110, US

(21) Appl. No.: 12/080,425

(22) Filed: Apr. 1, 2008

(51) Int. Cl. G06F 17/00

(52) U.S. Cl. 715/205

(57) ABSTRACT

Associating first metadata with a first element in a first document. The first metadata describes at least a location of the first element within the first document. Storing the first metadata extrinsically from the first document. Identifying a first link based on the first metadata. Displaying the first link.

### TECHNICAL FIELD

This document relates to information management, and in particular linking between and/or amongst documents.

### BACKGROUND

Bookmarking or “tagging” content has become a common social and business process and an element in information management and information sharing. The popularity of tagging has been driven in part by web sites such as del.icio.us and flickr. In these sites, users attach free-form strings of keywords, or “tags,” to Universal Resource Locators (URLs) to improve the usability of URLs, e.g., by making them easier to catalog, retrieve, and describe. A social or collaborative dimension contributes further by making it easier for tagged URLs to be shared among people and processes. This approach is believed to enhance relevancy of search results. Sharing or collaborative tagging has even begun to impact traditional ways of indexing and classifying documents.

In the Internet context, tags represent hyperlinks to the URL of the document. For example, a document entitled foo.doc located at http://www.foo.com/foo.doc can be bookmarked for publication and sharing by URL only. Some documents, for example web pages or other documents written in a mark-up language, carry an internal structure capable of supporting more particular links. For example, the author of a web page may define sections of the web page, and users can tag particular sections. In such cases, the definition of the sections occurs in the document itself. Thus, someone interested in tagging a portion of the document that does not

correspond to a pre-defined taggable section must edit the document (i.e., create the section) before tagging.

### SUMMARY

In general, in one aspect: associating first metadata with a first element in a first document, the first metadata describing at least a location of the first element within the first document; storing the first metadata extrinsically from the first document; identifying a first link based on the first metadata; and displaying the first link.

Implementations may include one or more of the following features: Also including identifying a first tag based on the first metadata, and displaying the first tag. Also including creating the first document. The first document includes a link directory. The first document resides on a storage medium, and the first metadata is stored on a different storage medium. Also including identifying a first document object model associated with the first document, wherein the link is determined based further on the first document object model. Also including identifying a first coordinate system associated with the first document, wherein the link is determined based further on the first coordinate system. The document bears a second coordinate system different from the first coordinate system. The first element is identified based on input from a user, the method further comprising receiving the first metadata from a user. Also including presenting the user with options for the first metadata, in which input from the user includes a selection from the options. The user input consists of a single action from the user. The single action is selected from the group consisting of: a mouse click, a pen stroke, a voice command, a key press, and a gesture. The link points to a second element of a second document. Also including: associating second metadata with the second element, the second metadata describing at least a location of the second element in the second document; storing the second metadata extrinsically from the second document; wherein the link is identified based further on the second metadata. The link points to a second element of the first document.

Other aspects include other combinations of the features recited above and other features, expressed as methods, apparatus, systems, program products, computer-readable media, and in other ways.

Other features and advantages will be apparent from the description and from the claims.

### DESCRIPTION OF DRAWINGS

FIG. 1 is a schematic depiction of a document.

FIG. 2 is a schematic depiction of metadata.

FIG. 3 is a schematic depiction of intra-document linking.

FIGS. 4-7 are flowcharts.

FIGS. 8-9 are block diagrams.

FIG. 10 is a schematic depiction of a computing device.

### DETAILED DESCRIPTION

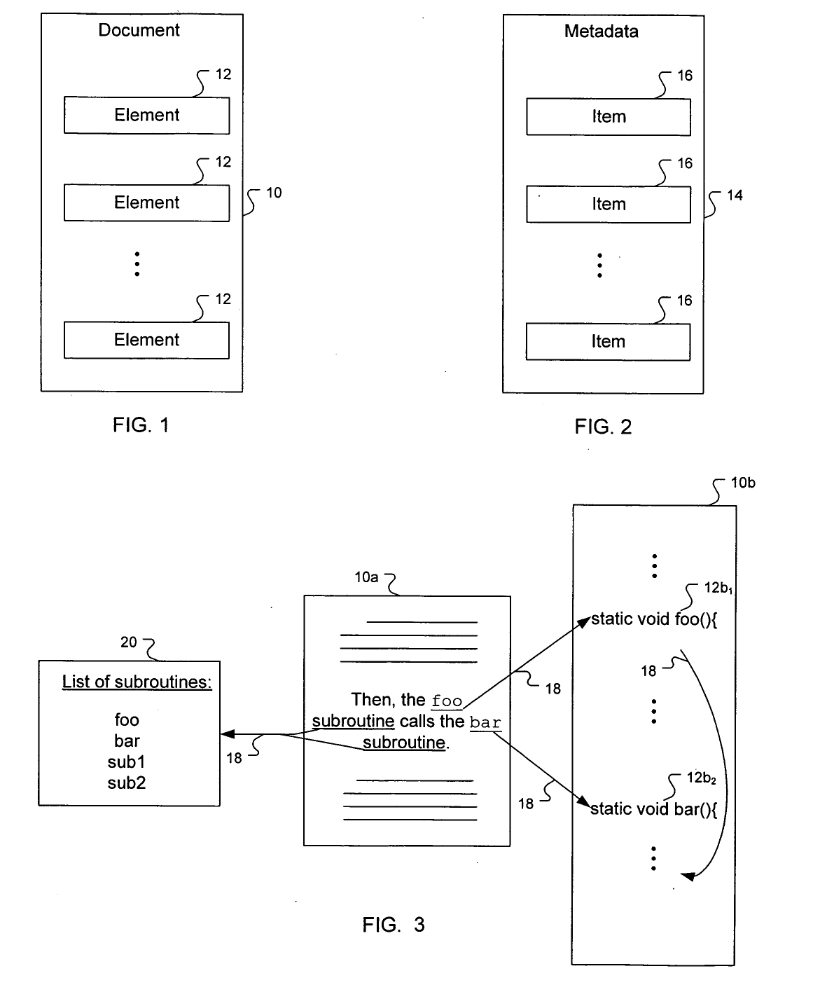

Referring to FIG. 1, a document 10 contains a number of elements 12. As used herein, “document” refers to any electronically-stored collection of information. A document 10 need not be stored as a single file or on a single storage medium. For example, a web page may be considered a single document, despite the fact that the text of the web page is stored in one file on one computer system, and the images of the web page are stored in other, separate files on other, separate computer systems. Other examples of documents 10 include, but are not limited to, text-based files (web pages, spread sheets, databases, source code, etc.), pictures, schematics such as computer-aided design (CAD) files, 3D/4D file formats, audio files, video files, or combinations of any of the above.

As used herein, an “element” is any addressable part of a document 10, except the entire document itself. For example: in a text-based document, any portion of text (including a single letter) is an element 12; in a spreadsheet, any combination of cells (including a single cell and/or any addressable portion of a cell's inner content) is an element 12; in a schematic any combination of components (including a single component) is an element 12; in a 3D/4D file any one of a three-dimensional position, orientation, geometry, surface, texture, model, moment in time, and/or scene is an element 12; in a video file any combination of frames (including a single frame) is an element 12, etc. Although FIG. 1 depicts elements 12 discretely in a list, elements may be hierarchically organized.

As a non-example of an element 12, in many text-based document formats such as American Standard Code for Information Interchange (ASCII), portions of a single character are not addressable. For example, the dot on an “i” or a “j” is not separately addressable from the entire character. Thus, for documents 10 in such formats, the dots on these characters are non-elements.

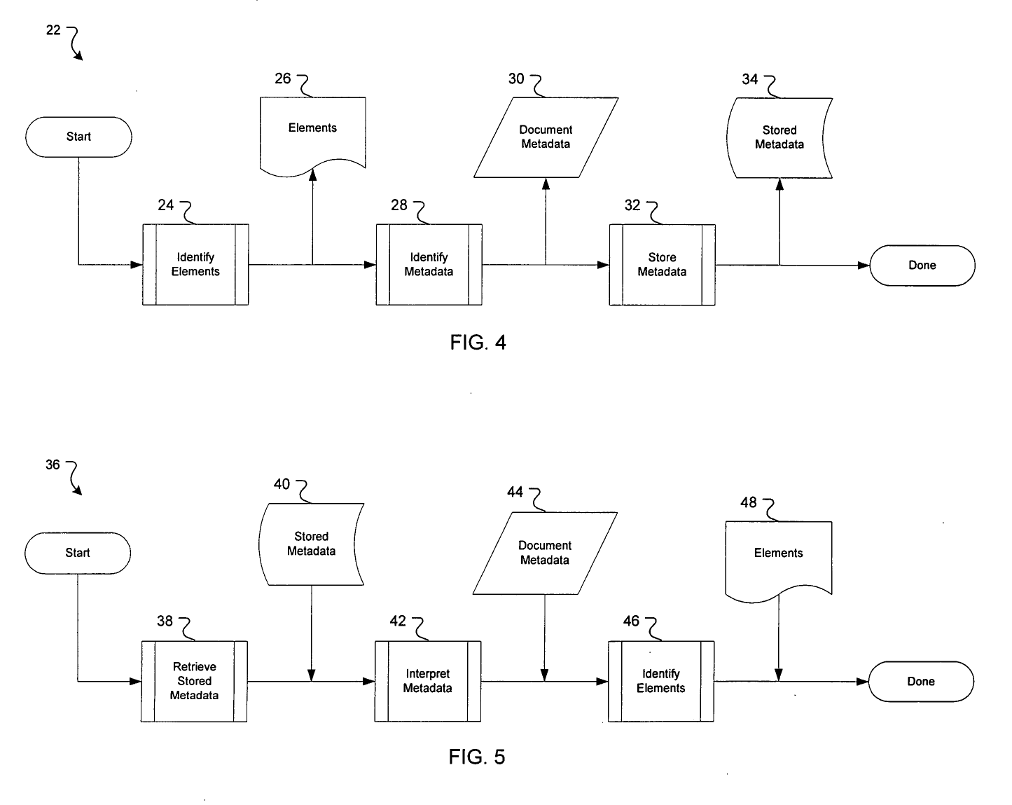

Referring to FIG. 2, a portion of metadata 14 includes various items 16. As used herein, “metadata” is data describing the context, content or structure of a document 10 and the document's management through time. Each datum describing context, content, or structure of a document 10 at a given time is a separate item 16 of metadata 14. Examples of metadata 14 include an author of the document, an element range within a document, a physical coordinate within a document, a table of contents of a document, whether a particular element 12 is relevant to one or more specified topics, etc. An item 16 of metadata 14 is not limited to any form or representation. For example, an item 16 can be expressed as text, true/false values in a table, numerical values, or may have its own internal structure. Although depicted separately, metadata 14 associated with a document 10 may, but need not, reside within the document.

Often, it is useful for various documents 10 to be related by hyperlinks. As used herein, a “hyperlink” is a pointer from a document 10 (or element 12 of the document) to another document (or element of the document). Although the phrase “another document” has been used in the previous sentence, the pointer may be from one element 12 of a document 10 to another element 12 of the same document 10. A “tag” is a related concept to a hyperlink. A tag refers to a hyperlink together with the metadata describing the linked-to element or elements.

Links are useful for, e.g., allowing a user to navigate to a given portion of a document 10 or between documents. For example, for a person researching a topic by reading various documents, the person may desire a link to a particularly relevant section of a given document. In another example, if a technical phrase appears in a document 10, it may be convenient for the reader unfamiliar with the phrase to follow a link from the technical phrase to its definition.

Moreover, tags are often useful to conveniently organize information in a document 10. For example, in a schematic of a complex machine with various subsystems comprising various components, the components can be tagged with identifiers of which subsystem(s) they belong to. The tags can then be used, e.g., to display only desired subsystems.

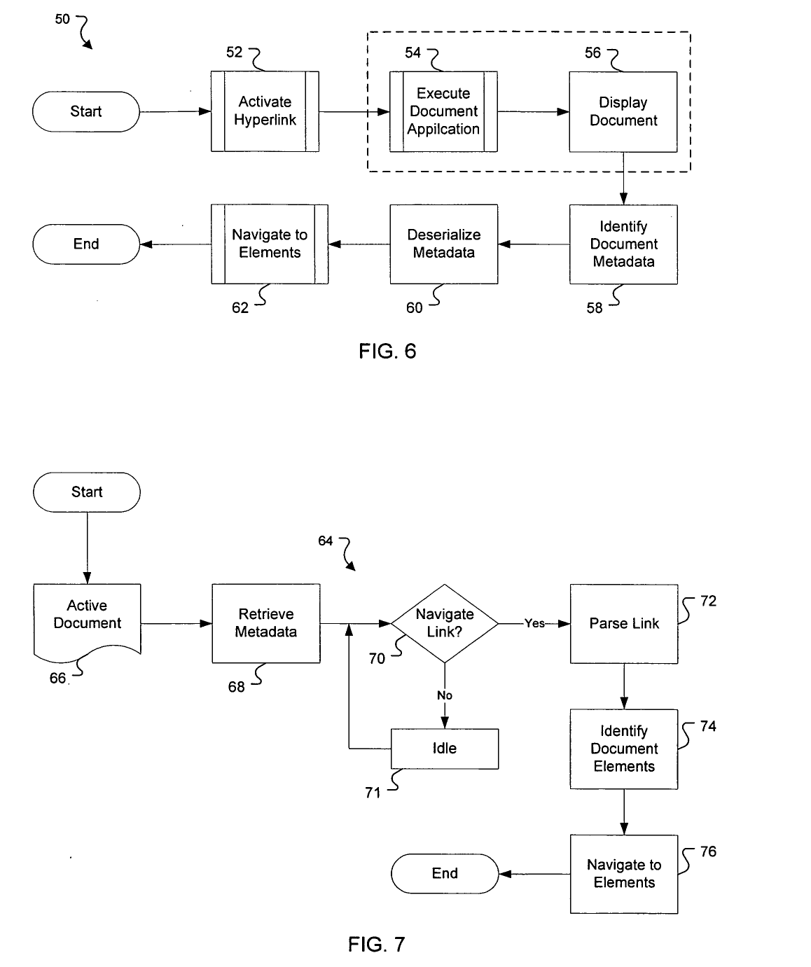

FIG. 3 is an exemplary depiction of linking between elements 12 in documents. For example, suppose document 10b consists of one million lines of source code for a particular computer program, including two subroutines: “foo” (element 12b₁) and “bar” (element 12b₂). Suppose further that document 10a is a specification describing the various portions of the source code 10b. It may be convenient to link corresponding portions of the specification 10a and the source code 10b. In FIG. 3, there is a link 18 from the word “foo” in document 10a to the “foo” subroutine 12b₁, and a link 18 from the word “bar” in document 10a to the “bar” subroutine 12b₂. It may also be convenient to link from one element 12 of a document 10 to another element of the same document. For example, in FIG. 3, there is a link 18 from the “foo” subroutine 12b, to the “bar” subroutine 12b₂, all within document 10b.

Moreover, suppose in document 10a and/or 10b, some elements 12 (such as the “foo” and “bar” subroutines) have been tagged with an attribute indicating that the element is a subroutine. One may use this set of tags to link to a list of all subroutines, e.g. in a separate window 20.

However, it is further desirable to enable one to link to particular elements 12 of a document 10 (e.g., linking to elements 12b₁ and 12b₂) without editing the document (e.g., creating sections, or otherwise editing document 10b to ensure the elements 12b₁ and 12b₂ are able to be linked to). For instance, in FIG. 3, the software specification (document 10a) may be written by one team of writers, while the source code (document 10b) may be written by a separate team of programmers. It may be undesirable or impractical to allow the writers to edit the source code without the programmers' knowledge or supervision.

The techniques described below allow, among other things, an author of a document 10 to link to a particular element 12 of a document without editing the linked-to document 10. Such links may be between different documents, or within a single document. Although phrases such as “from one document to another document” may be used below, all the linking techniques described in this document are applicable to linking between elements 12 of a single document 10 as well as from one document to a different document.

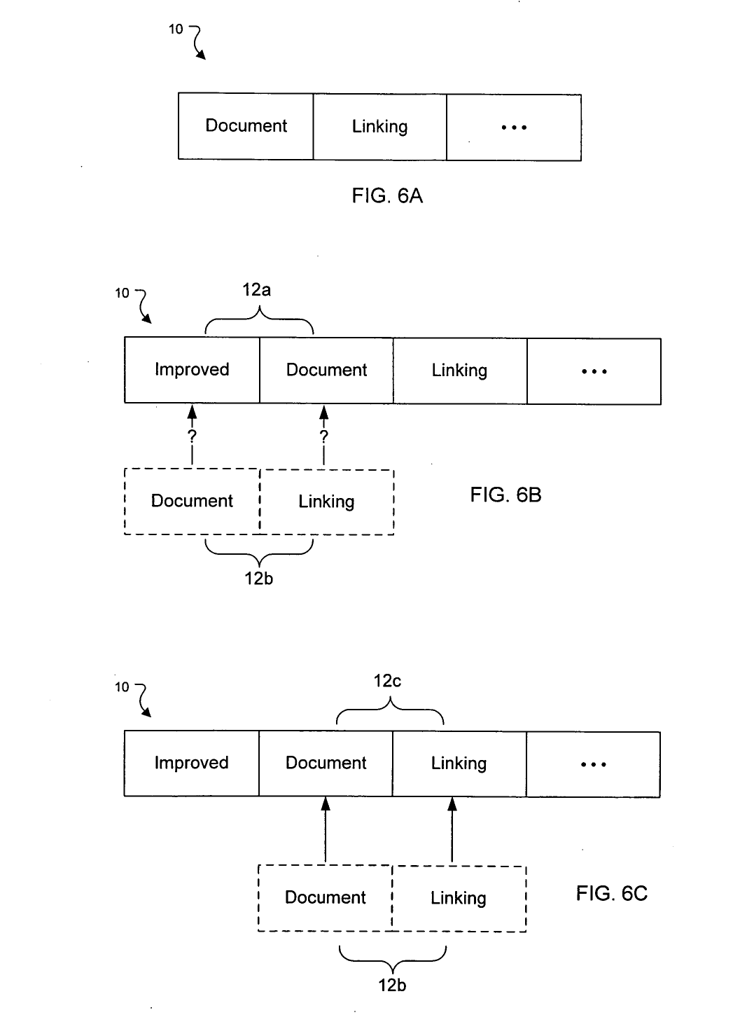

FIG. 4 is a flowchart showing a process 22 for associating metadata with one or more elements 12 of a document 10. In step 24, one or more elements from the document 10 are identified, creating a set 26 of identified elements. In some implementations, the elements 26 can be identified based on input from a user, or automatically based on pre-defined criteria.

In step 28, metadata 14 associated with the elements 26 is identified. In some implementations, the metadata 14 associated with the elements 26 includes pre-existing metadata 30 stored either intrinsically to or extrinsically from the document 10. In some implementations, the metadata 14 associated with the identified elements 26 also includes new metadata, e.g. metadata specified by a user prior to or during step 28.

The metadata identified in step 28 is subsequently stored (step 32). The stored metadata 34 need not reside at any particular location. In some implementations, the stored metadata 34 resides in a file separate from the document 10. Thus, even if a user or program executing process 22 has no write privileges to the document 10, the stored metadata 30 can successfully be written. In some implementations, the stored metadata 30 resides on a local computer of the user or program executing process 22. Additionally or alternatively, the metadata 30 can also be stored at a remote location, such as in a database on a server.

FIG. 5 is a flowchart showing a process 36 for associating elements 12 of a document with one or more items 16 of metadata 14. Process 36 is essentially an inverse of process 22. In step 38, one or more items of metadata 40 are identified. The identified metadata 40 is subsequently interpreted (step 42). From the interpreted metadata, one or more elements 48 of a document are identified (step 46). In some implementations, these elements 48 may be identified also using additional document metadata 44.

FIG. 6 is a flowchart showing a process 50 for following a hyperlink to an element of another document. In what follows below, it will be convenient to refer to a “target document.” A target document is one that contains one or more elements to which a hyperlink points.

First, a hyperlink is activated (step 52). The activation may be accomplished in any manner, e.g. performed by user, a computer, a process running on a computer, in response to a signal, etc. In some implementations, a user provides input (e.g. a keystroke or a mouse action) to a computer to activate the hyperlink.

After activating the hyperlink, an application may execute an application associated with the target document (step 54). For example, if the target document is written in hypertext markup language (“HTML”), a web browser may be executed in step 54. After executing the application, the target document may be displayed (step 56). Note that steps 54 and 56 are optional, and in general need not be performed.

Metadata associated with the target document is identified in step 58. The identified metadata may be stored in any location, or spread among several locations. For example, the metadata may be within the target document itself, and/or stored in one or more files besides the target document. The identified metadata is deserialized in step 60. Deserialization is the process by which data is read (e.g., from a storage medium or network connection) and subsequently translated into a usable form in memory. Deserialization of metadata includes, for example, instantiating in memory objects or structures described by the metadata. In particular, metadata describing the one or more elements that are linked to in the target document are represented in memory.

Next, in step 62, the one or more elements are navigated to. Since elements are by definition addressable, navigating to an element includes passing the address of the element to a program, process, or structure necessary to navigate to it. For example, navigating to an element may simply include creating or moving a logical pointer to the element. Navigating to an element may, alternatively or additionally, include retrieving and displaying the element from the target document, displaying the entire target document (with a focus on the element), or other navigation-actions.

In some implementations, elements of a document are addressable only in relative coordinates. Referring to FIG. 6A, for example, shows an exemplary document 10 beginning with the phrase “Document Linking.” Suppose this phrase has been linked to. The address information for “Document” may specify that it is the first word, while the address information for “Linking” may specify that it is the second word. Suppose, however, the document 10 is subsequently edited to contain a new first word, “Improved.” Now, the previous address information for the phrase “Document Linking” is no longer be correct. Therefore, following the old address information when navigating to the elements specified by the link may yield an incorrect result.

One way to avoid this problem is by performing an error detecting and/or error correcting procedure within step 62. One such procedure is as follows. In FIG. 6B, after navigating to the position of the target document specified by the metadata, a further check is performed to determine whether the actually-navigated-to elements 12a match the expected elements 12b. If not, then step 62 searches for nearby instances 12c of the expected elements 12b in the document 10, as shown in FIG. 6C.

FIG. 7 is a flowchart for a process 64 for checking a document for hyperlinks. Once a document 66 is active, the document's metadata is retrieved (step 68). An “active” document is a document that is currently deserialized. The active document's metadata may be in any location, or distributed among different locations. For example, the metadata may be within the active document 66 itself, or may be stored in one or more other files.

As the document 66 remains active (e.g., as a user reads the document), a decision 70 whether to navigate a link in the document exists. If no link is navigated, then process 64 idles (process 71). After idling, process 64 returns to decision 70. Optionally, a timeout threshold may be included (not shown), where idling an amount above the threshold causes process 64 to end.

Once a link is navigated, then the link is parsed (step 70). Parsing the link includes determining, from the structure and content of the link, what information the link contains, toward what information the link is pointing, etc. For example, the link may identify a characteristic of the active document 66 or one of its elements, or the link may simply point to another element in another target document.

After the link is parsed, one or more elements of the link's target document are identified (step 74). The identified elements are then navigated to (step 76). The navigation may take place as described above.

In some implementations, any or all of the steps above calling for reading or transcribing metadata can be accomplished by using a document object model. A document object model is a platform- and language-neutral interface that allows programs and/or scripts to dynamically access and update the content, structure, style, or other metadata 14 associated with a document 10.

In some implementations, any or all of the steps above calling for reading or transcribing metadata can be accomplished by using a coordinate system independent of any coordinate system that may exist within the document. For example, although a text document may be equipped with a native one-dimensional coordinate system (e.g., given by the order of the document's elements), any other coordinate system may be used, such as: a two dimensional coordinate system consistent with the document printed on a page; an n-dimensional coordinate system given by any hierarchical structure among elements of the document; etc.

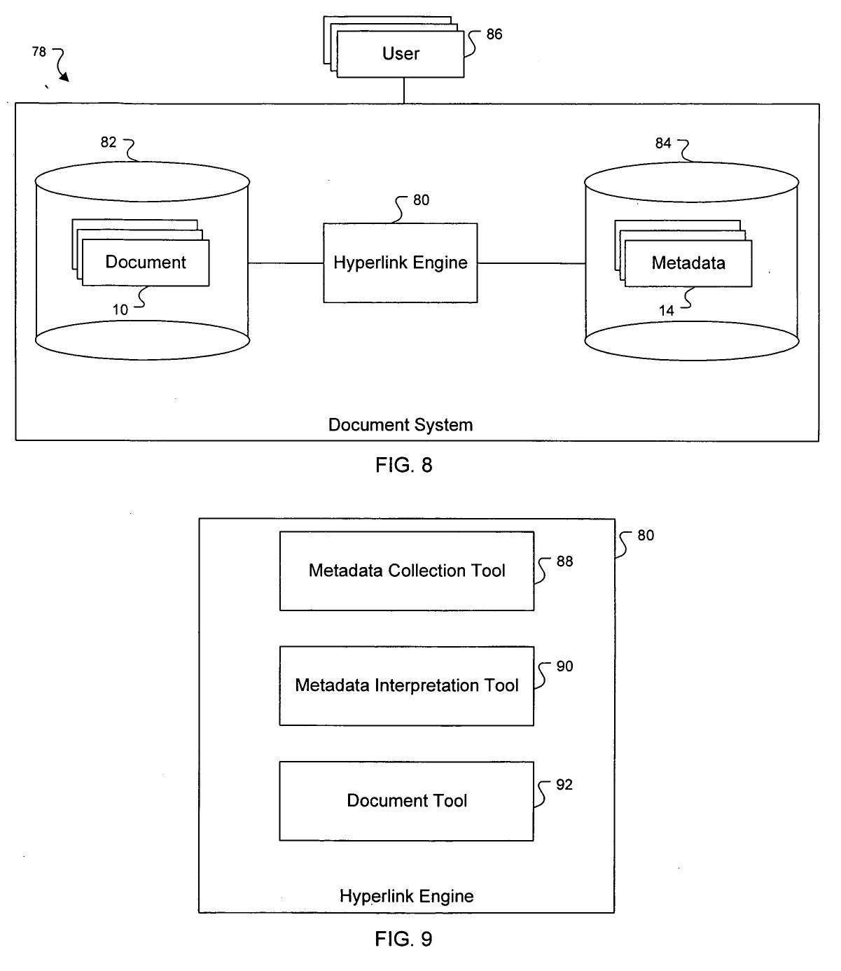

FIG. 8 is a block diagram for a document system 78. The document system 78 includes a hyperlink engine 80 in data communication with a document store 82 and a metadata store 84. The components 80-84 of the document system 78 are in mutual data communication, either directly or indirectly through other components. Moreover, the document system 78 is in data communication with one or more users 86. The data communication may be implemented in any manner, including direct physical connection (wire, fiber optic cable, etc.), indirect physical connection (over a communications network, a local area network, the internet, etc.), or wireless connection. Although the components 80-84 are depicted as single units, in general any such component may be implemented with a combination of hardware and/or software sub-components.

The document store 82 is operable to store one or more documents 10. Similarly, the metadata store 84 is operable to store metadata 14 associated with the documents 10 in the document store. The document store 82 and/or the metadata store 84 may each be implemented as one or more storage media. For example, either store 82, 84 may include magnetic media such as a hard drive, optical media such as a CD-ROM or DVD, solid-state media such as volatile or non-volatile memory, etc. In some implementations, the metadata 14 in the metadata store 84 are maintained as separate files from the documents 10 in the document store 82.

The hyperlink engine 80 is operable to carry out the hyperlinking techniques described above, including accessing documents 10 and their associated metadata 14. In particular, referring to FIG. 9, the hyperlink engine 80 includes a metadata collection tool 88, a metadata interpretation tool 90, and a document tool 92.

The metadata collection tool 88 is operable to identify, read, and/or write metadata 14. In some implementations, the metadata collection tool 88 is operable during steps 24, 28, 32, 38, 58, and/or 68 of FIGS. 4-7 described above.

The metadata interpretation tool 90 is operable to interpret, serialize, and/or deserialize metadata 14. In some implementations, the metadata interpretation tool 90 is configured to interact with one or more document object models and/or coordinate systems. In some implementations, the metadata interpretation tool 90 is operable during steps 32, 42, and/or 60 of FIGS. 4-7 described above.

The document tool 92 is operable to read, write, and navigate documents. In some implementations, the document tool 92 is operable during steps 24, 46, 62, 74, and/or 76 of FIGS. 4-7 described above. In some implementations, the document tool 92 may additionally create and/or serve a link directory associated with a particular user. The link directory is a document 10 containing various links 18 to other documents; e.g., links 18 that the associated user has created over time. In some implementations, the link directory may be served as a web page.

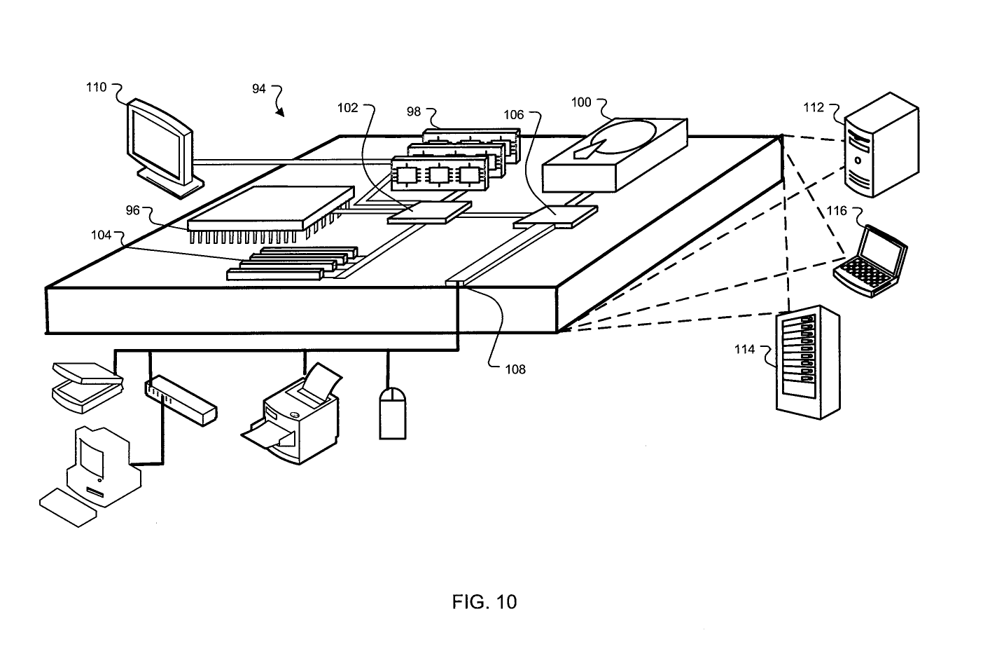

FIG. 10 is a block diagram of a computing device 94 that may be used to implement the document system 78, as either a client or as a server or plurality of servers. Computing device 94 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 94 includes a processor 96, memory 98, a storage device 100, a high-speed interface 102 connecting to memory 98 and high-speed expansion ports 104, and a low speed interface 106 connecting to low speed bus 108 and storage device 100. Each of the components 96, 98, 100, 102, 104, 106, are interconnected using various busses, and may be mounted on a common motherboard or in other manners as appropriate. The processor 96 can process instructions for execution within the computing device 94, including but not limited to instructions stored in the memory 98 or on the storage device 100 to display graphical information for a GUI on an external input/output device, such as display 110 coupled to high-speed interface 102. In other implementations, multiple processors and/or multiple buses may be used, as appropriate, along with multiple memories and types of memory. Also, multiple computing devices 94 may be connected, with each device providing portions of the necessary operations (e.g., as a server bank, a group of blade servers, or a multi-processor system).

The memory 98 stores information within the computing device 94. In one implementation, the memory 98 is a computer-readable medium. In one implementation, the memory 98 is a volatile memory unit or units. In another implementation, the memory 98 is a non-volatile memory unit or units.

The storage device 100 is capable of providing mass storage for the computing device 94. In one implementation, the storage device 100 is a computer-readable medium. In various different implementations, the storage device 100 may be a floppy disk device, a hard disk device, an optical disk device, or a tape device, a flash memory or other similar solid state memory device, or an array of devices, including but not limited to devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 98, the storage device 100, memory on processor 96, or a propagated signal.

The high-speed interface 102 manages bandwidth-intensive operations for the computing device 94, while the low speed interface 106 manages lower bandwidth-intensive operations. Such allocation of duties is exemplary only. In one implementation, the high-speed interface 102 is coupled to memory 98, display 110 (e.g., through a graphics processor or accelerator), and to high-speed expansion ports 104, which may accept various expansion cards (not shown). In the implementation, low speed interface 106 is coupled to storage device 100 and low speed bus 108. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 94 may be implemented in a number of different forms, as shown in the figure. For example, it may be implemented as a standard server 130, or multiple times in a group of such servers. It may also be implemented as part of a rack server system 114. In addition, it may be implemented in a personal computer such as a laptop computer 116.

Various implementations of the document system 78 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including but not limited to at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including but not limited to a machine-readable medium that receives machine instructions as a machine-readable signal. The term “machine-readable signal” refers to any signal used to provide machine instructions and/or data to a programmable processor.

To provide for interaction with a user, the document system 78 can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including but not limited to acoustic, speech, or tactile input.

The document system 78 can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the document system 78), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method comprising:
associating first metadata with a first element in a first document, the first metadata describing at least a location of the first element within the first document;
storing the first metadata extrinsically from the first document;
identifying a first link based on the first metadata; and
displaying the first link.

2. The method of claim 1, further comprising identifying a first tag based on the first metadata, and displaying the first tag.

3. The method of claim 1, further comprising creating the first document.

4. The method of claim 3, in which the first document includes a link directory.

5. The method of claim 1, wherein the first document resides on a storage medium, and the first metadata is stored on a different storage medium.

6. The method of claim 1, further comprising identifying a first document object model associated with the first document, wherein the link is determined based further on the first document object model.

7. The method of claim 1, further comprising identifying a first coordinate system associated with the first document, wherein the link is determined based further on the first coordinate system.

8. The method of claim 7, wherein the document bears a second coordinate system different from the first coordinate system.

9. The method of claim 1, wherein the first element is identified based on input from a user, the method further comprising receiving the first metadata from a user.

10. The method of claim 9, further comprising presenting the user with options for the first metadata, in which input from the user includes a selection from the options.

11. The method of claim 10, in which the user input consists of a single action from the user.

12. The method of claim 11, wherein the single action is selected from the group consisting of: a mouse click, a pen stroke, a voice command, a key press, and a gesture.

13. The method of claim 1, in which the link points to a second element of a second document.

14. The method of claim 13, further comprising:
associating second metadata with the second element, the second metadata describing at least a location of the second element in the second document;
storing the second metadata extrinsically from the second document;
wherein the link is identified based further on the second metadata.

15. The method of claim 1, in which the link points to a second element of the first document.

16. A computer-readable medium comprising instructions that, when executed by a computer, cause the computer to:
associate first metadata with a first element in a first document, the first metadata describing at least a location of the first element within the first document;
store the first metadata extrinsically from the first document;
identify a first link based on the first metadata; and
display the first link.

17. The medium of claim 16, further comprising instructions for identifying a first tag based on the first metadata, and displaying the first tag.

18. The medium of claim 16, further comprising instructions for creating the first document.

19. The medium of claim 18, in which the first document includes a link directory.

20. The medium of claim 16, wherein the first document resides on a storage medium, and the instructions cause the computer to store the first metadata on a different storage medium.

21. The medium of claim 16, further comprising instructions for identifying a first document object model associated with the first document, in which the tag is identified based further on the first document object model.

22. The medium of claim 21, further comprising instructions for identifying a first coordinate system associated with the first document, wherein the link is determined based further on the first coordinate system.

23. The method of claim 22, wherein then the document bears a second coordinate system different from the first coordinate system.

24. The medium of claim 16 further comprising instructions for receiving the first metadata from a user's input.

25. The medium of claim 24, further comprising instructions for presenting the user with options for the first metadata, in which the user's input includes a selection from the options.

26. The medium of claim 25, in which the user's input consists of a single action from the user.

27. The medium of claim 26, in which the single action is selected from the group consisting of: a mouse click, a pen stroke, a voice command, a key press, and a gesture.

28. The medium of claim 27, in which the link points to a second element of a second document.

29. The medium of claim 28, the medium further comprising instructions for:
associating second metadata with the second element, the second metadata describing at least a location of the second element in the second document;
storing the second metadata extrinsically from the second document;
in which the link is identified based further on the second metadata.

30. The medium of claim 27, in which the link points to a second element of the first document.
